(19) United States
(12) Patent Application Publication
(10) Pub. No.: US 2010/0109553 A1
(43) Pub. Date: May 6, 2010

(54) LED BULB WITH ZENER DIODE, ZENER DIODE ASSEMBLY OR RESISTOR CONNECTED IN SERIES

(76) Inventors: Chu-Cheng CHANG, Hsinchu City (TW); Cheng-Fen Chang, Hsinchu City (TW); Chen-Hsien Chang, Hsinchu City (TW); Chen-Tao Chang, Hsinchu City (TW)

Correspondence Address: BIRCH STEWART KOLASCH & BIRCH, PO BOX 747, FALLS CHURCH, VA, 22040-0747, US

(21) Appl. No.: 12/265,247

(22) Filed: Nov. 5, 2008

(51) Int. Cl. H05B 37/02

(52) U.S. Cl. 315/291

(57) ABSTRACT

An LED bulb in one embodiment includes two depending arms; a Zener diode secured to one end of one arm; an LED secured to one end of the other arm; a conductor electrically interconnecting the Zener diode and the LED; and an enclosure formed of epoxy resin with the Zener diode, the LED, the conductor, and one ends of the arms being concealed therein, wherein either a cathode of the LED is connected in series with a cathode of the Zener diode or an anode of the LED is connected in series with an anode of the Zener diode. The LED is adapted to emit red, green, or blue light.

### BACKGROUND OF THE INVENTION

1. Field of Invention

The invention relates to LED (light-emitting diode) lighting devices and more particularly to an LED bulb with improved characteristics.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

Conventionally, LED bulbs are operated in the voltage range of 1.9 to 3.8 volt. Note that in the following description voltage and current are DC (direct current) voltage and current respectively. A conventional LED bulb is shown in FIG. 1. LED of the LED bulb has an operating voltage of 3.5 volt. A voltage of 7 volt applied to the LED bulb may burn out. Hence, it is typical of connecting a resistor or Zener diode in series with the LED for reducing voltage as detailed below.

An example of the above conventional LED bulb is shown in FIG. 2. The LED bulb comprises a blue LED having an operating voltage of 3 volt and a Zener diode 1 having a Zener voltage (i.e., reverse breakdown voltage) of 3.9 volt. Hence, the LED bulb may operate normally when 6.9V power is applied thereto.

Another example of the above conventional LED bulb is shown in FIG. 3. The LED bulb comprises a red LED having an operating voltage of 2.2 volt and a resistor 1 of 500Ω. Hence, the LED bulb may operate normally when 12.2V power is applied thereto.

However, the well known LED bulb suffers from a disadvantage. In detail, the LED and the resistor or Zener diode are connected together by soldering which may cause pollution. Also, soldering may cause damage to the LED bulb, i.e., low yield. Thus, the need for improvement still exists.

### SUMMARY OF THE INVENTION

It is therefore one object of the invention to provide an LED bulb having a Zener diode, Zener diode assembly, or resistor connected in series.

The above and other objects, features and advantages of the invention will become apparent from the following detailed description taken with the accompanying drawings.

### BRIEF DESCRIPTION OF THE DRAWINGS

FIG. 1 is a schematic perspective view of a conventional LED bulb;

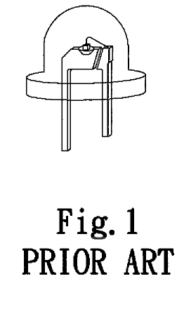

FIG. 2 is a schematic perspective view of an example of the conventional LED bulb in which an LED is connected in series with a Zener diode;

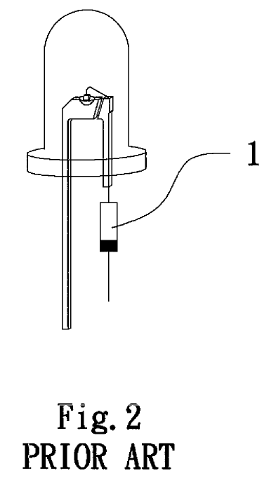

FIG. 3 is a schematic perspective view of another example of the conventional LED bulb in which an LED is connected in series with a resistor;

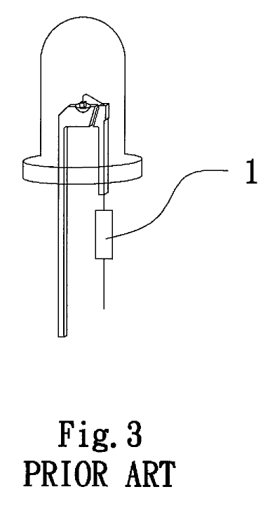

FIG. 4 is a schematic perspective view of a first preferred embodiment of LED bulb according to the invention in which negative electrode of a blue LED is connected in series with negative electrode of a Zener diode;

FIG. 5 is a view similar to FIG. 4 in which positive electrode of the blue LED is connected in series with positive electrode of the Zener diode;

FIG. 6 is a schematic perspective view of a second preferred embodiment of LED bulb according to the invention in which negative electrode of a red LED is connected in series with a resistor;

FIG. 7 is another view of FIG. 6;

FIG. 8 is a schematic perspective view of a third preferred embodiment of LED bulb according to the invention in which negative electrode of a green LED is connected in series with negative electrode of a Zener diode;

FIG. 9 is a view similar to FIG. 8 in which positive electrode of the green LED is connected in series with positive electrode of the Zener diode;

FIG. 10 is a circuit diagram of an LED bulb according to the invention in which negative electrode of an LED is connected in series with negative electrode of a Zener diode;

FIG. 11 is a circuit diagram of another LED bulb according to the invention in which positive electrode of an LED is connected in series with positive electrode of a Zener diode;

FIG. 12 is a circuit diagram of still another LED bulb according to the invention in which negative electrode of an LED is connected in series with positive electrode of a Zener diode assembly;

FIG. 13 is a circuit diagram of yet another LED bulb according to the invention in which positive electrode of an LED is connected in series with positive electrode of a Zener diode assembly; and

FIG. 14 is a circuit diagram of the LED bulb of FIG. 6.

### DETAILED DESCRIPTION OF THE INVENTION

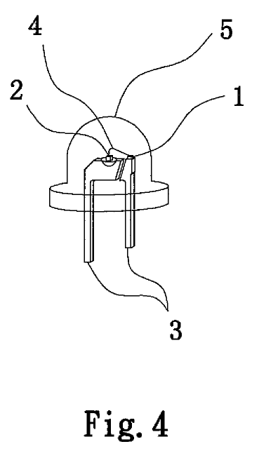

Referring to FIGS. 4 to 14, an LED bulb in accordance with the invention is illustrated.

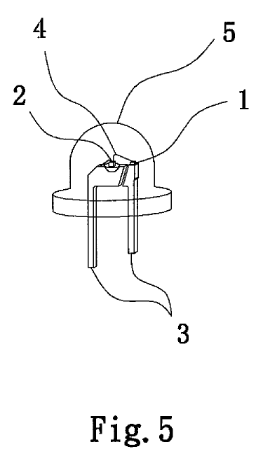

Referring to FIGS. 4 and 5 specifically, a first preferred embodiment of LED bulb is shown. The LED bulb comprises two depending arms 3, a Zener diode 1 secured to one end of one arm 3, an LED 2 secured to one end of the other arm 3, a metal conductor 4 interconnecting the Zener diode 1 and the LED 2, and a dome 5 formed of epoxy resin with the Zener diode 1, the LED 2, the conductor 4, and one ends of the arms 3 being concealed therein.

In an exemplary example (see FIG. 4), negative electrode (i.e., cathode) of a blue LED 2 secured to one end of the other arm 3 by soldering is connected in series with negative electrode of a Zener diode 1 secured to one end of one arm 3 by soldering. The blue LED 2 has an operating voltage of 3 volt and the Zener diode 1 has a Zener voltage (i.e., reverse breakdown voltage) of 3 volt. Hence, the LED bulb may operate normally when a voltage of 6 volt is applied thereto.

In another exemplary example (see FIG. 5), positive electrode (i.e., anode) of a blue LED 2 secured to one end of the other arm 3 by soldering is connected in series with positive electrode of a Zener diode 1 secured to one end of one arm 3 by soldering. The blue LED 2 has an operating voltage of 3 volt and the Zener diode 1 has a Zener voltage (i.e., reverse breakdown voltage) of 3 volt. Hence, the LED bulb may operate normally when a voltage of 6 volt is applied thereto.

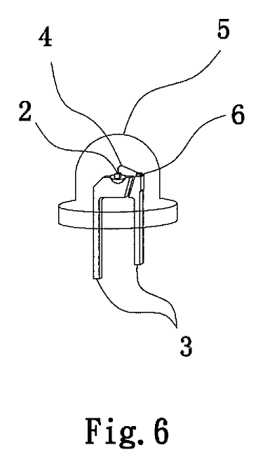

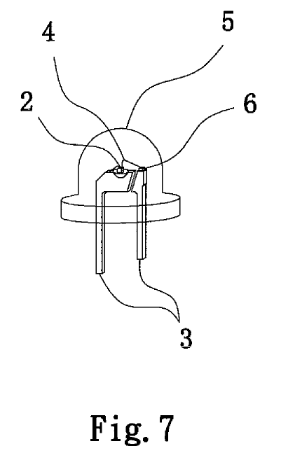

Referring to FIGS. 6 and 7 specifically, a second preferred embodiment of LED bulb is shown. The LED bulb comprises two depending arms 3, a resistor 6 secured to one end of one arm 3, an LED 2 secured to one end of the other arm 3, a metal conductor 4 interconnecting the resistor 6 and the LED 2, and a dome 5 formed of epoxy resin with the resistor 6, the LED 2, the conductor 4, and one ends of the arms 3 being concealed therein.

In an exemplary example (see FIGS. 6 and 7), negative electrode of a red LED 2 secured to one end of the other arm 3 by soldering is connected in series with the resistor 6 secured to one end of one arm 3 by soldering. The red LED 2 has an operating voltage of 2 volt and the resistor 6 has a resistance of 250Ω. Hence, the LED bulb may operate normally when a voltage of 7 volt is applied thereto.

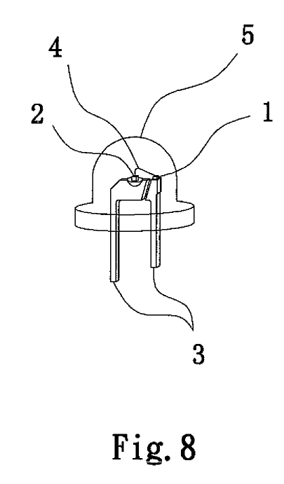

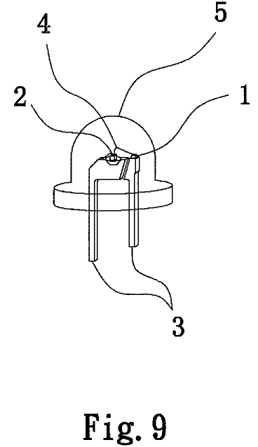

Referring to FIGS. 8 and 9 specifically, a third preferred embodiment of LED bulb is shown. The LED bulb comprises two depending arms 3, a Zener diode 1 secured to one end of one arm 3, an LED 2 secured to one end of the other arm 3, a metal conductor 4 interconnecting the Zener diode 1 and the LED 2, and a dome 5 formed of epoxy resin with the Zener diode 1, the LED 2, the conductor 4, and one ends of the arms 3 being concealed therein.

In an exemplary example (see FIG. 8), negative electrode of a green LED 2 secured to one end of the other arm 3 by soldering is connected in series with negative electrode of a Zener diode 1 secured to one end of one arm 3 by soldering. The green LED 2 has an operating voltage of 3 volt and the Zener diode 1 has a Zener voltage (i.e., reverse breakdown voltage) of 9 volt. Hence, the LED bulb may operate normally when a voltage of 12 volt is applied thereto.

In another exemplary example (see FIG. 9), positive electrode of a green LED 2 secured to one end of the other arm 3 by soldering is connected in series with positive electrode of a Zener diode 1 secured to one end of one arm 3 by soldering. The green LED 2 has an operating voltage of 3 volt and the Zener diode 1 has a Zener voltage (i.e., reverse breakdown voltage) of 9 volt. Hence, the LED bulb may operate normally when a voltage of 12 volt is applied thereto.

Alternatively, the Zener diode may be replaced by a resistor having a resistance of 450Ω.

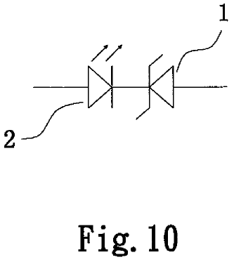

Referring to FIG. 10, a circuit diagram of an LED bulb according to the invention is shown. As shown, negative electrode of the LED 2 is connected to negative electrode of the Zener diode 1. Also, the LED 2 has an operating voltage of 3 volt and the Zener diode 1 has a Zener voltage (i.e., reverse breakdown voltage) of 7 volt. Hence, the LED bulb may operate normally when a voltage of 10 volt is applied thereto.

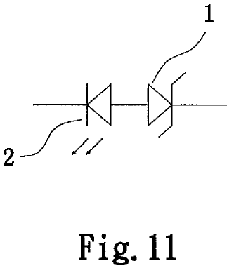

Referring to FIG. 11, a circuit diagram of another LED bulb according to the invention is shown. As shown, positive electrode of the LED 2 is connected to positive electrode of the Zener diode 1. Also, the LED 2 has an operating voltage of 3 volt and the Zener diode 1 has a Zener voltage (i.e., reverse breakdown voltage) of 7 volt. Hence, the LED bulb may operate normally when a voltage of 10 volt is applied thereto.

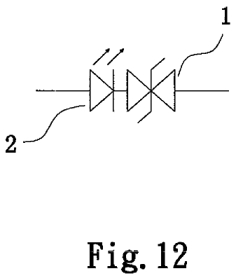

Referring to FIG. 12, a circuit diagram of still another LED bulb according to the invention is shown in which negative electrode of an LED 2 is connected in series with positive electrode of a Zener diode assembly 1. The Zener diode assembly 1 has a first Zener diode and a second Zener diode in which cathode of the first Zener diode is connected to cathode of the second Zener diode. Also, the LED 2 has an operating voltage of 2 volt and the Zener diode assembly 1 has a Zener voltage (i.e., reverse breakdown voltage) of 5 volt. Hence, the LED bulb may operate normally when a voltage of 7 volt is applied thereto.

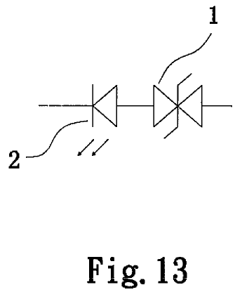

Referring to FIG. 13, a circuit diagram of yet another LED bulb is shown in which positive electrode of an LED 2 is connected in series with positive electrode of a Zener diode assembly 1. The Zener diode assembly 1 has a first Zener diode and a second Zener diode in which cathode of the first Zener diode is connected to cathode of the second Zener diode. Also, the LED 2 has an operating voltage of 2 volt and the Zener diode assembly 1 has a Zener voltage (i.e., reverse breakdown voltage) of 5 volt. Hence, the LED bulb may operate normally when a voltage of 7 volt is applied thereto.

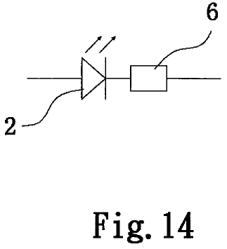

Referring to FIG. 14, a circuit diagram of the LED bulb of FIG. 6 is shown. The LED 2 has an operating voltage of 3.1 volt and the resistor 6 a resistance of 450Ω. Current flowing through both the LED 2 and the resistor 6 is 20 mA. Hence, voltage drop across the resistor 6 is 9 volt (i.e., V=IR, 9V=20 mA×450Ω according to Ohm's law). Hence, the LED bulb may operate normally when a voltage of 12.1 volt is applied thereto.

While the invention herein disclosed has been described by means of specific embodiments, numerous modifications and variations could be made thereto by those skilled in the art without departing from the scope and spirit of the invention set forth in the claims.

What is claimed is:

1. An LED light source comprising:
two depending arms;
a Zener diode secured to one end of one arm;
an LED secured to one end of the other arm;
a conductor electrically interconnecting the Zener diode and the LED; and
an enclosure formed of epoxy resin with the Zener diode, the LED, the conductor, and one ends of the arms being concealed therein,
wherein either a cathode of the LED is connected in series with a cathode of the Zener diode or an anode of the LED is connected in series with an anode of the Zener diode.

2. The LED light source of claim 1, wherein the LED is adapted to emit red, green, or blue light.

3. An LED light source comprising:
two depending arms;
a resistor secured to one end of one arm;
an LED secured to one end of the other arm;
a conductor electrically interconnecting the resistor and the LED; and
an enclosure formed of epoxy resin with the resistor, the LED, the conductor, and one ends of the arms being concealed therein,
wherein a cathode of the LED is connected in series with the resistor.

4. The LED light source of claim 3, wherein the LED is adapted to emit red, green, or blue light.

5. An LED light source comprising:
two depending arms;
a Zener diode assembly secured to one end of one arm;
an LED secured to one end of the other arm;
a conductor electrically interconnecting the Zener diode assembly and the LED; and
an enclosure formed of epoxy resin with the Zener diode assembly, the LED, the conductor, and one ends of the arms being concealed therein,
wherein either a cathode of the LED is connected in series with an anode of the Zener diode assembly or an anode of the LED is connected in series with the anode of the Zener diode assembly.

6. The LED light source of claim 5, wherein the Zener diode assembly comprises a first Zener diode and a second Zener diode, and wherein a cathode of the first Zener diode is connected to a cathode of the second Zener diode.

7. The LED light source of claim 5, wherein the LED is adapted to emit red, green, or blue light.
